(19) United States
(12) Patent Application Publication
(10) Pub. No.: US 2015/0161574 A1
(43) Pub. Date: Jun. 11, 2015

(54) STEWARDSHIP METHOD FOR MANAGING OZONE-DEPLETING SUBSTANCES

(71) Applicant: EOS CLIMATE, INC., San Francisco, CA (US)

(72) Inventors: Saskia Feast, San Rafael, CA (US); Joseph Madden, San Francisco, CA (US)

(21) Appl. No.: 14/537,386

(22) Filed: Nov. 10, 2014

Related U.S. Application Data
(60) Provisional application No. 61/903,045, filed on Nov. 12, 2013.

(51) Int. Cl. G06Q 10/00

(52) U.S. Cl. CPC G06Q 10/30; G06Q 10/20

(57) ABSTRACT

A stewardship system integrates the destruction of ozone depleting substances, such as chlorofluorocarbons (CFC), carbon credit generation, sale of carbon credits within the various carbon credit markets, and distribution of the profits to the contributing entities. A central processing entity mediates transactions between the different entities.

### RELATED APPLICATION

This application claims priority to U.S. Provisional Patent Application No. 61/903,045 filed on Nov. 12, 2013, the entire content of which is incorporated herein by reference.

### FIELD OF THE INVENTION

This application relates in general to methods and systems for managing carbon credits by providing an interface between customers using CFCs and other ozone-depleting substances, companies that offer services and technology to destroy such substances, and the ability to derive value from the destruction in the form of tradable carbon credits.

### BACKGROUND

Carbon credits have come into use as financial derivatives to encourage the reduction of emissions of greenhouse gases such as carbon dioxide (CO₂) into the atmosphere. Property owners who can show verifiable reduction in CO₂ emissions or other GHG emissions (CO₂e), or who show verifiable destruction of ozone-depleting substances (ODS) can qualify for carbon credits. Markets have formed to trade such emissions reductions as commodities among buyers and sellers.

One of the goals of the carbon trading market goal is to allow market mechanisms to drive industrial and commercial processes in the direction of low emissions or less carbon-intensive approaches. While there are companies that sell assist other customers in lowering their carbon footprints, a system is needed that integrates the various parties in the use of refrigerants, the creation of carbon credits from the destruction of CFCs, and trading in which credits can be sold and traced across the market from the source to the customer.

### SUMMARY

The various embodiments provide a method for managing destruction of ozone-depleting substances (ODS), including: receiving ODS from at least one customer; providing the ODS to a destruction process, wherein the destruction of ODS creates carbon credits; selling a first portion of the carbon credits on a carbon credit market; receiving proceeds from the sale of the carbon credits; and sharing the proceeds from the sale of the carbon credits with a destruction entity, and in which the ODS from the plurality of customers have different destruction values based on the customer, wherein the different destruction values are expressed as different values of the carbon credits created.

In an embodiment, the ODS are chlorofluorocarbons (CFCs). Another embodiment includes verifying a result from the ODS destruction process. Another embodiment includes verifying the ODS destruction process for compliance with standards maintained by the carbon credit market. In another embodiment, the at least one customer is a developing country, and at least one purchaser of the carbon credits on the carbon credit market is a developed country.

Another embodiment provides a method for managing the lifecycle of refrigerant gases, including receiving a refrigerant gas from at least one customer, and tracking the refrigerant gas back to reclamation, Specifically, an embodiment method includes tracking distribution of a first container of clean refrigerant gas to a cooling system site; tracking installation of the clean refrigerant gas, in which the clean refrigerant gas is transferred from the first container into the cooling system; and tracking removal of a used refrigerant gas from the cooling system into a second container; and tracking recycling of the used refrigerant gas, in which contaminants are removed from the used refrigerant gas to reclaim the clean refrigerant gas.

In an embodiment, tracking recycling of the used refrigerant gas may include generating recycling information about the used refrigerant gas, in which the recycling information comprises information about the tracked distribution, installation, and removal steps; and computing an environmental benefit calculation based on the use of a recycled refrigerant gas that includes the reclaimed clean refrigerant gas.

### BRIEF DESCRIPTION OF THE DRAWINGS

The accompanying drawings, which are incorporated herein and constitute part of this specification, illustrate exemplary aspects of the invention. Together with the general description given above and the detailed description given below, the drawings serve to explain features of the invention.

FIG. 1 illustrates a schematic diagram of an ODS management system according to an embodiment.

FIG. 2 illustrates a schematic diagram of an ODS management system according to an embodiment.

FIG. 3 is a schematic diagram of a global ODS management system according to an embodiment.

FIG. 4 is a process flow diagram illustrating an ODS management method according to an embodiment.

FIG. 5A is a process flow diagram illustrating a refrigerant management method according to an embodiment.

FIG. 5B is a process flow diagram illustrating a refrigerant recycling method according to an embodiment.

FIG. 6 is a component block diagram of a laptop computer suitable for implementing the various embodiment methods.

FIG. 7 is a component block diagram of a server suitable for implementing the various embodiment methods.

FIGS. 8 and 9 are respective component block diagram and front view of a mobile computing device suitable for implementing the various embodiment methods.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

As used herein, “ODS” refers to ozone depleting substances, such as chlorofluorocarbons (CFCs) and other halogenated man-made chemicals. While the various embodiments herein reference CFC management, such reference merely serves as an example and not to limit the applicability of the methods and systems to other ODSs.

As used herein, “green house gas” or “GHG” refers to a gas in the atmosphere that absorbs and emits radiation within the thermal infrared range, thereby contributing to the greenhouse effect.

GHGs, such as CO₂, are emitted from fossil fuel production, are considered to be partly responsible for global warming. As a result, many international efforts are under way to reduce emissions of GHGs. For example, the Kyoto Protocol treaty, which many countries are signatories to, requires industrialized countries to reduce total emissions by an average of 5 percent below their 1990 levels between 2008 and 2012. In order to accomplish this goal, some countries have developed a cap and trade system that puts a price on emissions and enables producers to trade credits on an open market. In other countries, such as the United States, participation in GHG reduction efforts is voluntary, but many businesses actively choose to utilize processes and manufacturing systems that have lower GHG emissions. For example, U.S. companies across multiple industries advertise reduced emissions in conjunction with their products or services. Further, U.S. companies also need to comply with Kyoto Protocol regulations if they do business in countries committed to that treaty.

In particular, environmental markets have developed worldwide, addressing needs of voluntary and regulation-mandated companies for GHG emissions reduction. For example, private carbon market cap and trade systems may allow members to trade GHG allowances for GHGs such as carbon dioxide, methane, nitrous oxide, hydrofluorocarbons, perfluorocarbons and sulfur hexafluoride.

Carbon credits in a system may be comprised of allowance credits and/or offset credits. Allowances (i.e., emissions allowances) may be calculated as the difference between a GHG-emitting member's actual GHG emission levels and the allowed GHG emission levels. For example, each unit of allowance may give the member owner the right to emit a specific amount of CO₂ or other GHG equivalent.

Offsets programs exist that ensure the environmental integrity of GHG emissions reduction projects and to create value in the carbon market in the form of offset credits. For example, the Climate Action Reserve provides protocols for project development and the quantification of carbon offset credits. To be registered on the Reserve, GHG reduction projects are verified by an independent third party as adhering to criteria established in the protocols. After a project registered on the Reserve it is issued offset credits known as Climate Reserve Tonnes (CRTs).

Offset project types include land use, such as deforestation reduction by creating substitutes for forest-based products, and emissions-reduction in developing countries (e.g., Clean Development Mechanism (CDM)-eligible projects under the Kyoto Protocol), which allow industrialized countries to invest in emission-reducing projects in developing countries rather than in their own.

In particular, another significant project type is ODS destruction. CFCs, which are a type of ODS, have been used in the past in air conditioning/cooling units, as aerosol spray propellants, and as foam blowing agents.

In the various embodiments, a system is created that efficiently manages ODS destruction (e.g., CFC destruction) as emissions offset projects in order to create and trade carbon credits. In the various embodiments, the system is maintained by a Central Processing Entity. The Central Processing Entity, which may be one or multiple servers, may be configured with connections to the Internet and to other communication networks to enable computer-to-computer communications, computer displays coupled to the servers to support a human operator, and/or telephones sufficient to enable one or more individuals to effect the coordination of the various steps in CFC management.

The Central Processing Entity may maintain information relating to multiple carbon trading protocols, and may be configured to sell carbon credit units in one or many of the existing carbon credit exchanges (Chicago Climate Exchange, European Climate Exchange, NASDAQ OMX Commodities Europe, PowerNext, Commodity Exchange Bratislava and the European Energy Exchange). The Central Processing Entity may be configured to sell carbon credit units in many of these markets. Further, the Central Processing Entity may be able to receive data or notices from independent third-party verifiers endorsed by different carbon exchanges, thereby ensuring that a proposed emissions offset project complies specifically with a selected carbon trading protocol before carbon credits are generated for that project (e.g., ODS destruction project).

In a preferred embodiment, the Central Processing Entity may be in communication with CFC Destruction Entities, U.S. customers, and foreign customers, and may receive and share information from each of these entities. In an example embodiment, the ODS Destruction Entity is an appliance recycler that uses equipment and processes to eliminate environmentally harmful substances such as CFCs from discarded appliances.

Information that may be received from these entities may also be implemented into a CFC destruction plan by the Central Processing Entity. Functions that may be performed by the Central Processing Entity also include tracking the destruction of ODS (e.g., CFCs), calculating the amount of payment to be apportioned to each party, receiving and transferring metrics on CFCs to customers, and other related processes. The Central Processing Entity may bundle CFCs for processing, for example, according to the customer from whom they were received, the location, the type of contract, etc.

The Central Processing Entity may receive communications from independent CFC destruction verifiers in order to comply with a particular protocol's requirements for reporting. For example, a CFC destruction verifier may evaluate the process used by a particular ODS Destruction Entity and may generate a compliance indicator that is sent to the Central Processing Entity along with an identifying number of the ODS Destruction Entity. The Central Processing Entity may require that for each ODS Destruction Entity with which it does business, a new compliance indicator is received after a certain periodic interval.

Further, the Central Processing Entity may receive communications from independent third party verifier in conjunction with the approval process for a carbon offset project. For example, market-endorsed third party verifiers who evaluate and approve emissions offset projects may provide approval for a particular market, thus enabling the offsets to be traded as carbon credits on that market. Such approval may be transmitted directly to the Central Processing Entity prior to sale of the carbon credits. The Central Processing Entity may further be configured to evaluate differences between different carbon credit markets and, for each group of CFC destruction generated offsets (i.e., carbon credits), to select a market that is favorable based on various criteria. Moreover, the Central Processing Entity may also monitor and update information regarding one or more carbon credit markets, either on a fixed interval or following the sale of carbon credits by the Central Processing Entity.

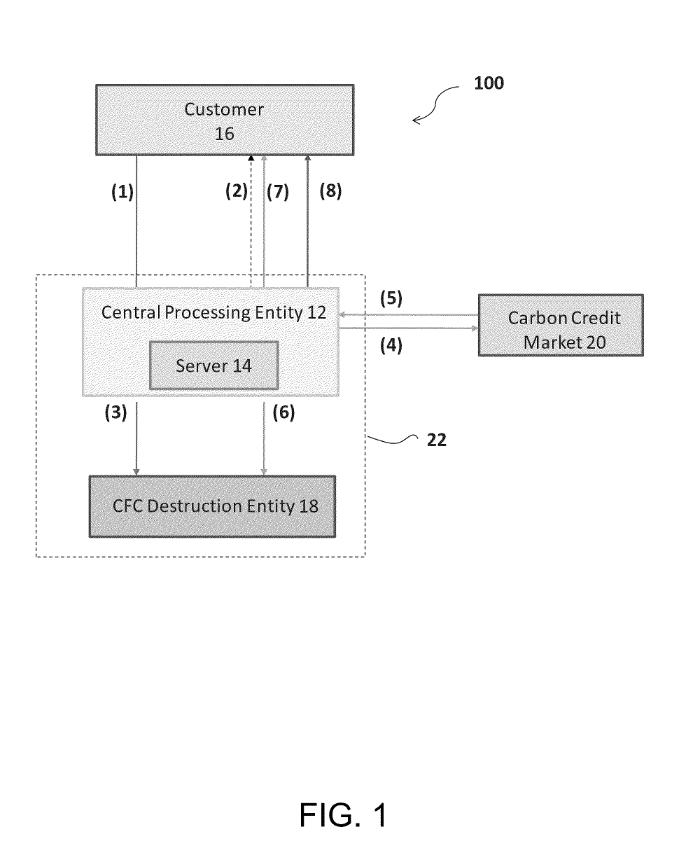

FIG. 1 illustrates the components of a CFC management system 100, according to a preferred embodiment. A Central Processing Entity 12 operates a central command server 14 for the CFC management system. The Central Processing Entity directly transacts with a Customer 16, the ODS Destruction Entity 18, and the Carbon Credit Market 20. The Central Processing Entity 12 and the ODS Destruction Entity 18 may be separate companies or entities, or optionally may be part of the same entity 22

The process steps involved in the CFC management system 10 are also shown in FIG. 1, according to one embodiment. In step (1), the Customer 16 may provide the Central Processing Entity 12 with the ODS (e.g., CFCs) it owns or uses. The Customer 16 can provide ODS directly to the ODS Destruction Entity 18 and provide information regarding the ODS to the Central Processing Entity 12. Alternatively, the Customer 16 may provide the ODS and information regarding the ODS to the Central Processing Entity 12. This step may be taken, for example, pursuant to an outputs contract between the Customer 16 and the Central Processing Entity 12. In optional step (2), the Central Processing Entity 12 may prepay the Customer for CFCs delivered, for example, in an amount-per-pound. In step (3), the Central Processing Entity 12 may provide the ODS Destruction Entity 18 with all of its acquired CFCs and payment to process and destroy the CFCs. In step (4), the Central Processing Entity 12 may provide generated carbon credits from CFC destruction by the ODS Destruction Entity 18 to the Carbon Credit Market 20. In step (5), the Central Processing Entity 12 may receive payment for the sale of carbon credits in the Carbon Credit Market 20. In step (6) the ODS Destruction Entity 18 may receive a percentage of the revenue from the sale of carbon credits from the Central Processing Entity 12, or the Central Processing Entity 12 may pay a fixed fee to the ODS Destruction Entity 18 for CFC destruction. In step (7), the Customer 16 may also receive a percentage of the revenue from the sale of carbon credits from the Central Processing Entity 12. In step (8), the Central Processing Entity 12, by the central command server 14, may compute the metrics on the pounds of CFCs that are no longer used by the Customer 16 by virtue of the completed carbon credit transaction, and the central command server 14 may provide this information to the Customer 16.

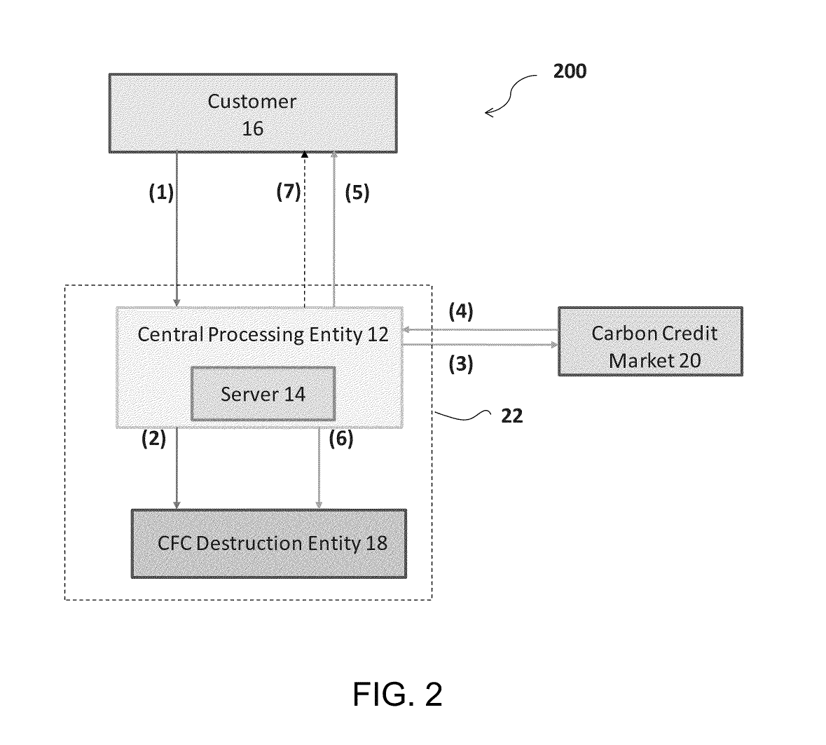

FIG. 2 illustrates the components of a CFC management system 200 according to an alternative embodiment. As in the system described above with reference to FIG. 1, a Central Processing Entity 12 manages emissions reductions to generate carbon credits through operation of the central command server 14. The Central Processing Entity directly transacts with the. Customer 16, the ODS Destruction Entity 18, and the Carbon Credit Market 20. In step (1), the Customer 16 may provide the Central Processing Entity 12 with the CFCs it owns or uses. This step may be taken, for example, pursuant to an outputs contract between the Customer 16 and the Central Processing Entity 12. In step (2), the Central Processing Entity 12 may provide the ODS Destruction Entity 18 with all of its acquired CFCs and payment to process and destroy the CFCs. In step (3), the Central Processing Entity may provide a first portion of the carbon credits generated from by the processing done by the ODS Destruction Entity 18 to the Carbon Credit Market 20. In step (4), the Central Processing Entity 12 may receive payment for the first portion of the carbon credits from sale in the Carbon Credit Market 20. In step (5), the Customer 16 may receive from the Central Processing Entity 12 the second portion of the carbon credits generated by the ODS Destruction Entity 12. In step (6), the ODS Destruction Entity 18 may receive a percentage of the revenue from the sale of carbon credits from the Central Processing Entity 12. Optionally, in step (7) the Customer 16 may also receive a portion of the payment from the Central Processing Entity 12 for the sale of the first portion of carbon credits. Thus, in this embodiment the Customer 16 receives at least part of its compensation in carbon credits instead of money.

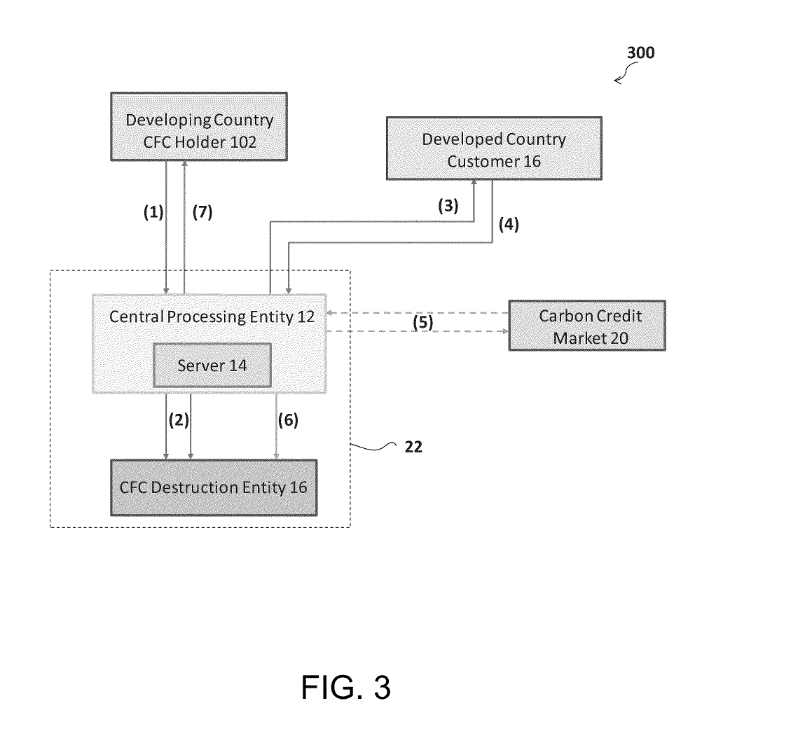

FIG. 3 illustrates the components of a CFC management system 30 according to an alternative embodiment that incorporates carbon credit trading with developing countries. Current protocols in GHG and ODS reduction already provide for special status with respect to developing countries. For example, under Article 5 of the Montreal Protocol, a Multilateral Fund is in place to assist developing country parties whose annual per capita ODS consumption and production is less than 0.3 kg to comply with the control measures of the Protocol (referred to as Article 5 countries). Further, the Clean Development Mechanism under Article 12 of the Kyoto is designed to assist developing countries contribute to GHG emission reduction.

The economic basis for including developing countries in efforts to reduce emissions is that emission cuts are generally less expensive in developing countries than developed countries, but the atmospheric effect is globally equivalent. In this alternative, the developed country (e.g., the United States) is given credits for meeting its emission reduction targets, while the developing country would receive the capital investment and clean technology or beneficial change in land use. Developing countries are generally referred to herein as “Developing country CFC holders,” which this is not intended to limit the scope of the claims to any specifically implemented carbon exchange platform, or to limit the scope of the claims to any one set of criteria for developing countries.

As in systems 100 and 200 described above with reference to FIGS. 1 and 2, a Central Processing Entity 12 manages emissions offsets to generate carbon credits through operation of the central command server 14. In this CFC management system 30, the Central Processing Entity 12 mediates carbon credit transactions between Developing country CFC holder 102, Developed country (e.g., U.S.) Customer 16, ODS Destruction Entity 18, and Carbon Credit Market 20.

In step (1), the Developing country CFC holder 102 may provide the Central Processing Entity 12 with the CFCs it owns or uses. This step may be taken, for example, pursuant to an outputs contract between the Developing country CFC holder 102 and the Central Processing Entity 12. In step (2), the Central Processing Entity 12 may provide the ODS Destruction Entity 18 with all of its acquired Article 5 CFC along with payment for processing and destruction. Alternatively, the Developing country CFC holder 102 may provide its acquired Article 5 CFC to the ODS Destruction Entity 18 and provide payment and information about the Article 5 CFC to the Central Processing Entity 12. In step (3), the Central Processing Entity 12 may provide Article 5 carbon credits generated by the CFC destruction to the U.S. Customer 16, and the U.S. Customer 16 in step (4) may provide the Central Processing Entity 12 with the CFCs it owns or uses. This step may be taken, for example, pursuant to an outputs contract between the U.S. Customer 16 and the Central Processing Entity 12. In step (5), the Central Processing Entity may sell the U.S. carbon credits on the Carbon Credit Market 20. In step (6), the ODS Destruction Entity 18 may receive a percentage of the revenue received by the Central Processing Entity 12 for selling the U.S. carbon credits in step (5). The Central Processing Entity 12 may provide the U.S. CFCs received from the U.S. Customer 16 to the ODS Destruction Entity 18 along with the Article 5 CFCs in step (2). In step (7), the Central Processing Entity 18 pays the Developing country CFC holder 102 a certain amount-per-ton for Article 5 carbon credits generated.

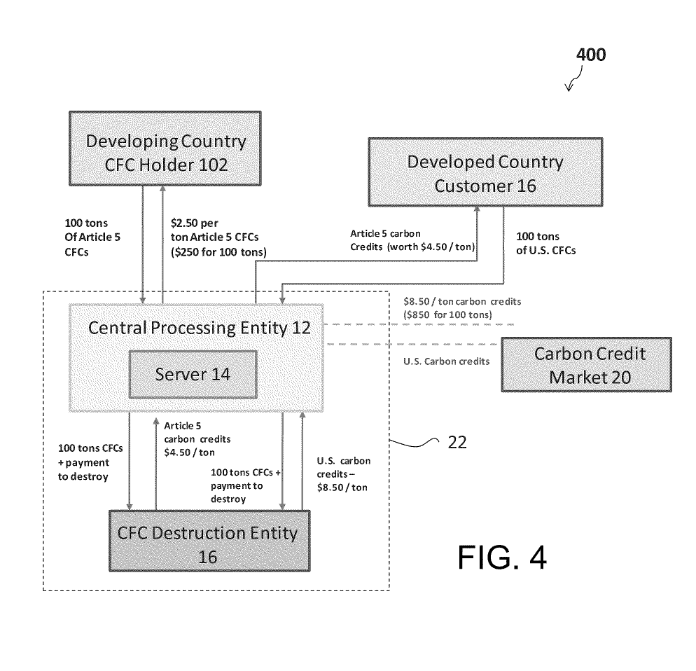

FIG. 4 illustrates an example transaction 400 using CFC management system 300. For the purpose of providing an example, and without any limitation to the scope of the present application, at the time of the example transaction 40 the value of Article 5 carbon credits is $4.50 per ton, and the value of U.S. carbon credits is $8.50 per ton. These numbers are not meant to reflect the actual value of carbon credits at any point in time, but merely are used to enable this example. In step (1), the Developing country CFC holder 102 transfers 100 tons of CFCs it owns or uses to the Central Processing Entity 12 or to the ODS Destruction Entity 18. In step (2), the Central Processing Entity 12 transfers the 100 tons of Article 5 CFCs to the ODS Destruction Entity 18, along with payment for their destruction. In turn the ODS Destruction Entity 18 destroys the 100 tons of Article 5 CFCs to generate 100 tons-equivalent of Article 5 carbon credits. The Article 5 carbon credits are transferred back to the Central Processing Entity 12. In step (3) the Central Processing Entity 12 transfers the 100 tons-equivalent of Article 5 carbon credits generated by the CFC destruction to a developed country Customer 16, and in exchange the Central Processing Entity 12 receives 100 tons of U.S. CFCs. In step (4), as was done with the Article 5 CFCs in step (2), the Central Processing Entity transfers the 100 tons of U.S. CFCs to the ODS Destruction Entity 18 along with payment to destroy. In turn the ODS Destruction Entity 18 destroys the 100 tons of U.S. CFCs to generate 100 tons-equivalent of U.S. carbon credits. The U.S. carbon credits, which are worth $8.50 per ton, are transferred back to the Central Processing Entity 12. In step (5), the U.S. carbon credits are sold on the carbon credit market for a total of $850, part of which is re-supplied to the ODS Destruction Entity 18 as the payment to destroy the U.S. CFCs in step (4). Further, from the $850 received in the sale of the 100 tons of U.S. carbon credits, in step (6) a portion is paid to the Developing country CFC holder 102 (for example, $250). Thus, the use of the CFC stewardship system is seen to benefit each of the parties that transact through the Central Processing Entity 12 in this example transaction: The Developing country CFC holder 102 is able to get rid of harmful CFCs and earn revenue from the transaction. The U.S. Customer 16 is also able to get rid of harmful CFCs and receive a payment in Article 5 carbon credits at an equivalent weight. The ODS Destruction Entity 18 provides its regular business service of CFC destruction in return for monetary payment. The Central Processing Entity keeps $600, minus what the Central Processing Entity 12 paid to the ODS Destruction Entity 18. Optionally, the Central Processing Entity 12 may pay part of the $600 to the Developing country Customer 102.

Another embodiment provides methods and systems for managing refrigerant gases by providing an interface between customers using refrigerants, companies that offer services and technology to supply, reclaim and remove refrigerant gases from residential and commercial systems, and companies offering end of life management for refrigerant gases, such as destruction as part of a carbon credit project or conversion to an environmentally benign species. Refrigerant gases that may be managed according to some embodiments may include ODSs (e.g., halons, CFCs, hydrochlorofluorocarbons (HCFCs), etc.). In other embodiments, the managed refrigerant gases may include any substance commonly used in the heat cycle of a refrigeration system (e.g., hydrofluorocarbons (HFCs), perfluorocarbons (PFCs), hydrocarbons, ammonia, etc.).

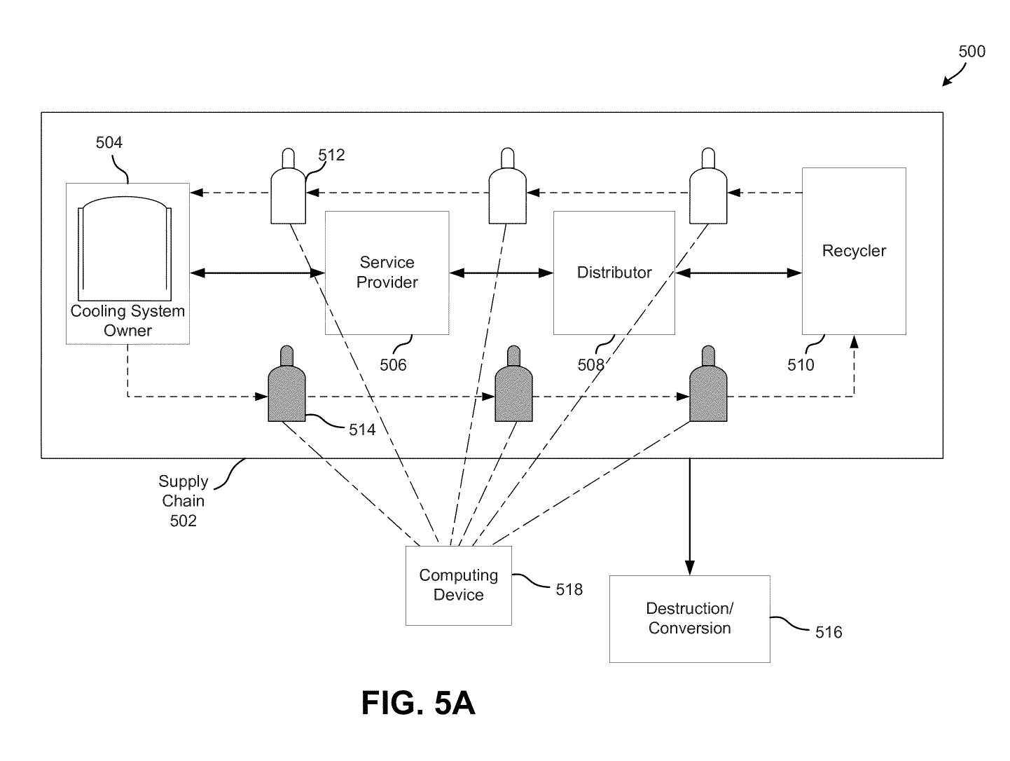

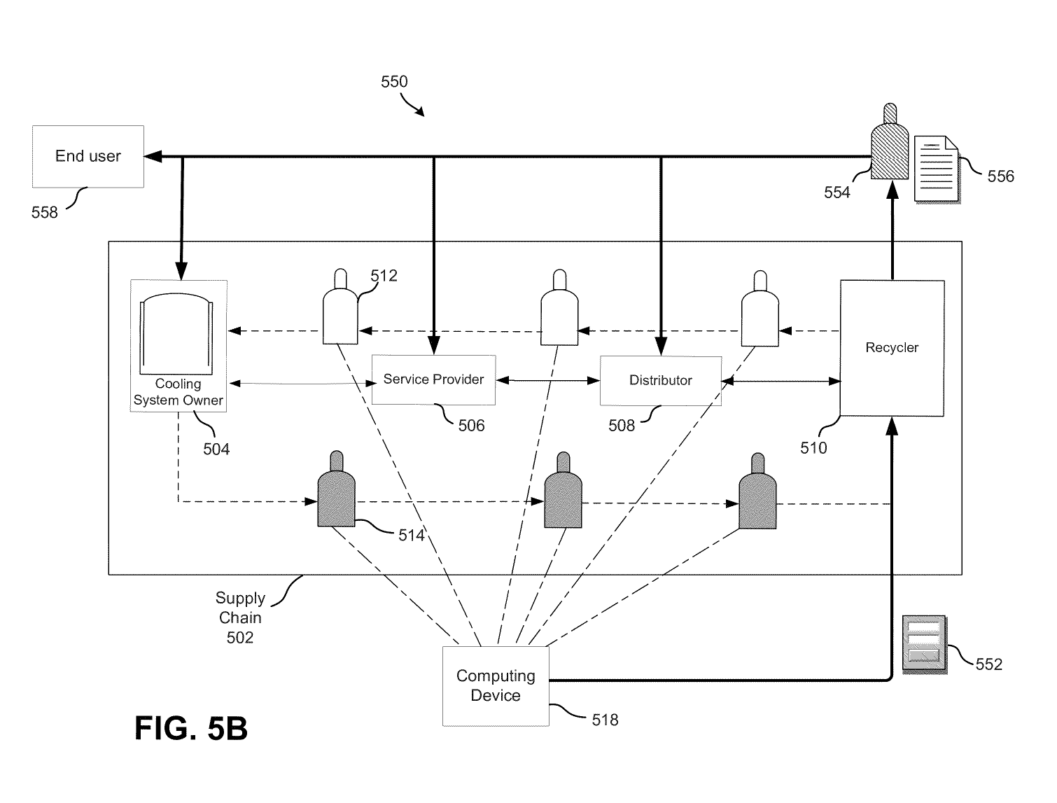

Another related goal for integrating various parties in the use of refrigerants involves the tracking and management of refrigerant gas units over their lifecycle, across various entities. While there are systems that track inventory and use of refrigerant gas with respect to a particular cooling system and/or entity, tracking the lifecycle of a gas among multiple entities, for example from its distribution to a user to destruction (or conversion) provides for a better comprehension of the environmental impacts. A further related goal for the tracking and management of refrigerant gas units over their lifecycle may be as part of a recycling program for refrigerant gases. Such a recycling program may provide additional climate change benefits and/or environmental certifications to participating end users. FIG. 5A illustrates a refrigerant gas management system 500. In an embodiment, the management system 500 may track refrigerant gas over its lifecycle, including transfer of the refrigerant gas across multiple entities that may or may not be under common control. For example, a supply chain 502 may include entities such as a cooling system owner 504, a service provider 506, a distributor 508, and a recycler 510, any of which may be replaced by one or more entities performing analogous functions.

Clean refrigerant gas may be transported to a cooling system in a container 512 (e.g., a gas cylinder), and may be installed in the cooling system, for example, by a service provider 506. After a period of time, used refrigerant gas may be removed from the cooling system, for example, into a container 514. The container 514 may be transferred across one or more entities of the supply chain. For example, the service provider 506 may remove used refrigerant gas and transfer the container 514 to a distributor 508. The distributor 508 may transfer the container 514 to a recycler 510, which may reclaim the starting clean refrigerant gas, such as in container 512, by removing contaminants from the used refrigerant gas. The recycler 510 may provide the container 512 to the distributor 508, who may provide it to the service provider 506, who may provide it to a cooling system owner. In another embodiment, a recycler 510 may accept, reclaim, and redistribute refrigerant gases in containers 512, 514 directly to/from the cooling system owner 504, without a service provider or distributor intermediary. In the various embodiments, container 514 may be the same as or different from container 512.

Throughout these transfer steps, various measurements and tracking identifications may be performed. For example, the clean or used refrigerant gas may be tracked based on weight of a container 512, 514, which may be recorded by a computing device 518. The computing device 518 may be any of a number of known types of devices, including, but not limited to, a desktop personal computing device, a notebook/laptop personal computing device, a mobile computing device, and a computer server.

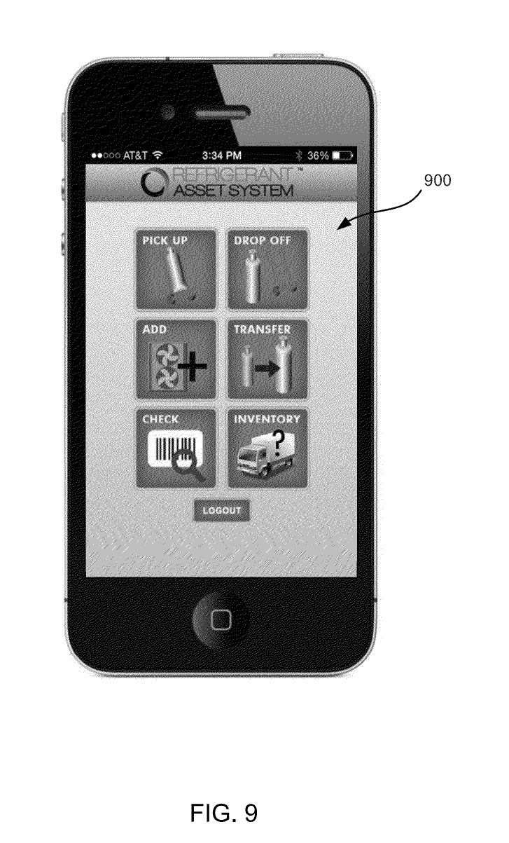

In various embodiments, computing device 518 may be a central management system configured to receive, monitor and store lifecycle tracking information. In another embodiment, computing device 518 may be one of multiple central management devices that form the central management system. In another embodiment, computing device 518 may be a remote system configured to collect lifecycle tracking information and to transmit the information to a separate central management system. Additionally, such remote system may be configured to retrieve lifecycle tracking information that may already be stored on the separate central management system, and to download and/or display the retrieved information to a user of remote system. The exchange of information between the remote system and the separate central management system may be performed using any of the various data communication protocols known in the art. An example of a remote system that may be implemented on a mobile device is discussed in further detail below with respect to FIG. 9. In another embodiment, computing device 518 may be a server operated by a third party (for example, EOS Climate, Inc.) or by one or more of a cooling system owner 504, a service provider 506, a distributor 508, and/or a recycler 510.

Notifications regarding the remaining lifecycle of a refrigerant gas may be provided to one or more entities in the supply chain 502. After a certain expiration point, the refrigerant gas may be destroyed or converted at a destruction entity 516, thereby ending its lifecycle. Further, refrigerant gases that are recycled (e.g., by a recycler 510 or other entity) may continue to move up and down the same supply chain 502 by being supplied to the same cooling system owner 504, or may enter a new supply chain by being supplied to a different cooling system owner (not shown). For example, a used refrigerant gas from cooling system owner 504 may be recycled, which reclaims clean refrigerant gas for a reserve of gases that supplies the cooling system and/or other systems in that facility. In an alternative example, after reclamation, the clean refrigerant gas may be resold to other customers in the central management system of computing device 518.

In an embodiment method, information may be provided to customers regarding the value of a refrigerant gas, its economic and environmental impact, and its history until retired. For example, the central management system of computing device 518 may generate reports that meet specific regulatory requirements, at state, regional, national and international levels. In another embodiment, environmental lifecycle metrics, such as emissions avoided, may be provided to users, and verified by independent third party auditor, for example, the owner of the central management system of computing device 518 or another party.

Embodiment systems may also provide financial lifecycle metrics of the refrigerant gases to users. For example, the price per unit of refrigerant gas may change over the course of time between refrigerant installation in the cooling system, use in the cooling system, removal of used refrigerant gas, and reclamation of clean refrigerant gas. Comparison between these prices may provide a positive or negative price variant. Further, there is always some degree of loss of mass associated with the use of the refrigerant gas by the cooling system and the subsequent reclamation process. That is, while in an ideal system the amount at the beginning and end of a refrigerant lifecycle remains unchanged, in practical conditions a small loss of refrigerant may be expected with each installation, removal, and reclamation. Therefore, measurements of mass for the containers 512, 514 may also be tracked and recorded by the central management system of computing device 518. In an embodiment, a system may provide a calculation of the current asset value, such as in response to user inquiry, of a particular refrigerant gas (e.g., in container 512) by applying the current price per unit of the refrigerant gas to its mass in the container of interest. In the same manner, the system may provide a calculation of the change in the value of a refrigerant gas over a period of time. For example, the system may provide changes in value by monitoring weight changes of the containers 512, 514, which may be tracked through barcodes on the exteriors of the containers 512, 514. In an embodiment, such tracking may be performed by a remote system such as computing device 518. For example, computing device 518 may be a mobile computing device configured with a scanner to collect the barcode tracking information, and to transmit the information to a central management system.

Embodiment systems may also be used to implement a recycling program for refrigerant gases. A recycling program may require transparency in the tracking through a supply chain, thereby enabling an end user to receive refrigerant gas that is verified as being recycled. Such transparency may be accomplished by tracking and recording each unit (e.g., pound or other unit) of refrigerant gas through the various parties shown in FIG. 5A.

FIG. 5B illustrates an example refrigerant gas recycling system 550 that may be part of a recycling program. As discussed above with respect to the refrigerant gas management system 500, the recycling system 550 may track refrigerant gas over its lifecycle, including transfer of the refrigerant gas across multiple entities in a supply chain 502. Such entities may include a cooling system owner 504, a service provider 506, a distributor 508, and/or a recycler 510, any of which may be replaced by one or more entities performing analogous functions. In an embodiment, a central server may compile recycling information 552 showing the supply chain for units of used refrigerant that are to be recycled and provided to end users. For example, the central management system of computing device system 518 may generate such recycling information 552, in addition to performing the tracking, measurement and identification functions described above with respect to FIG. 5A. In an alternative embodiment, the recycling information 552 may be generated by a separate central server (not shown) that communicates with the central management system of computing device 518.

In the various embodiments, recycled refrigerant gas may be generated by a recycler 510 through receiving used refrigerant gas, removing contaminants, and reclaiming clean refrigerant gas. The reclaimed clean refrigerant gas may be chemically identical to newly manufactured (e.g., previously unused) refrigerant gas of the same type. Thereafter, the recycler 510 may sell or otherwise transfer the reclaimed refrigerant gas as a recycled product to end users after coordinating with a central server in the recycling system 550 to obtain recycling information. Thus, the recycled refrigerant gas and newly manufactured refrigerant gas are considered “clean” refrigerant gas, as described above.

In an embodiment, the recycler 510 may request recycling information 552 from the computing device 518 by identifying a particular quantity of used refrigerant gas that has been or will be recycled. The recycler may identify, for example, one or more containers 514 of used refrigerant gas that it has received, and which has been tracked in the supply chain 502 by the central management system of computing device 518. The computing device 518 may gather the requested recycling information 552 and provide it to the recycler 510. The recycling information 552 may contain each tracked life cycle(s) of each intermediary source of the identified used refrigerant gas, and the original source of the clean refrigerant gas from which it was derived. For example, information 552 may have fields identifying tracked containers 514 from the request, the associated amount of refrigerant gas tracked through each container 514, and, working backward, each transfer between entities in the supply chain through the original purchasing entity that bought the clean refrigerant gas as new. In an embodiment, the transfers between various entities in the supply chain may include details such as the name and address of the transferor and transferee, time and date of the transaction, and a verification of the identifier and/or quantity associated with a transferred container. In some embodiments, used refrigerant gas in a container 514 may have entered the supply chain 502 in a different refrigerant gas container 512, in which case transfers between containers would be included in the recycling information 552.

The recycler 510 may generate the recycled refrigerant gas 554 from the used refrigerant gas received from an intermediary source or sources identified in the recycling information 552. In an embodiment, the recycler 510 may generate a recycling log 556 that contains, in a user-readable format, the recycling information 552 corresponding to each intermediary source used to make the recycled refrigerant gas 554. For example, if the recycled refrigerant gas 554 contains clean refrigerant gas reclaimed from two used refrigerant gas containers 514, the recycling log 556 may contain recycling information 552 for both source containers 514, along with an associated amount from each source. In other embodiments, the recycling log 556 may be generated by the central management server 512 or other entity, and received by the recycler 510 in place of recycling information 552. The recycled refrigerant gas 554 with corresponding recycling log 556 may be distributed to any of a variety of end users, for example, a cooling system owner 504, service provider 506, distributor 508, or an end user 558 outside the supply chain.

In an embodiment, the computing device 518, recycler 510, or other entity that provides recycling information 552 and/or a recycling log 556 may be configured to calculate an environmental benefit associated with the recycled refrigerant 554. In an embodiment, the entity may be a third party (i.e., unrelated to the life cycle tracking discussed above with respect to FIG. 5A) who also monitors, verifies, and certifies the recycling information 552 and/or recycling log 556. In this manner, the recycler 510 may use a certification of “100% recycled” along with other certifications such as “U.S. recycled” refrigerant gas versus imported, etc.

The environmental benefit may be calculated as a reduction in carbon footprint based on the use of recycled refrigerant instead of new refrigerant. A “carbon footprint” may be a calculation of the total sets of GHG emissions (e.g., expressed as carbon dioxide equivalent (CO₂e) using the relevant 100-year global warming potential (GWP100)) caused by an end user's activities. The environmental benefit may be measured as a number of metric tons, or other unit, of GHG emissions avoided by using the recycled refrigerant instead of new refrigerant. Further, the amount of GHG emissions involved in transporting the recycled refrigerant 554 from the recycler 510 to the end user (e.g., GHG emissions from transportation via truck, airplane, etc.) may be subtracted from the emissions avoided in calculating the environmental benefit. Further, the amount of GHG emissions involved in transporting the clean and used refrigerant through the supply chain 502 (for example, transporting containers 512, 514 between one or more of the cooling system owner 504, service provider 506, distributor 508, and recycler 510) may also be subtracted from the emissions avoided in calculating the environmental benefit. In this manner, the environmental benefit may be a more accurate portrayal of the actual overall emissions “savings.”

In another embodiment, a central server, such as computing device 518 or other entity central server, may maintain emissions data about an end user, and provide the end user with an environmental benefit calculation that includes the end user's updated carbon footprint. For example, the central server may communicate with a computer system of the end user to obtain emissions data used to compute a carbon footprint. The updated carbon footprint may be a carbon footprint calculation that is adjusted based on the GHG emissions avoided by the end user's use of the recycled refrigerant 554. In an embodiment, the end user's carbon footprint may be updated and provided to the end user after every purchase of recycled refrigerant 554 and/or periodically based on time intervals (e.g., annually, per quarter, etc.). For example, the central management system of computing device 518 may be configured to provide an updated carbon footprint calculation to an end user at the end of every year, which involves accounting in the calculation for all recycled refrigerant gas 554 purchased by the end user over the year-long interval.

In another embodiment, a system of credits may be developed, such as “cooling credits,” as a standardized measure of verified GHG emissions avoided by using recycled refrigerant gas 554. Such cooling credits may be part of a broader accreditation program for users to improve their respective carbon footprints. Alternatively, such cooling credits may be sold and/or transferred in a market system. For example, a cooling system owner 504 may receive recycled refrigerant gas 554 and may transfer the associated cooling credits to another end user 558 for monetary or other value compensation.

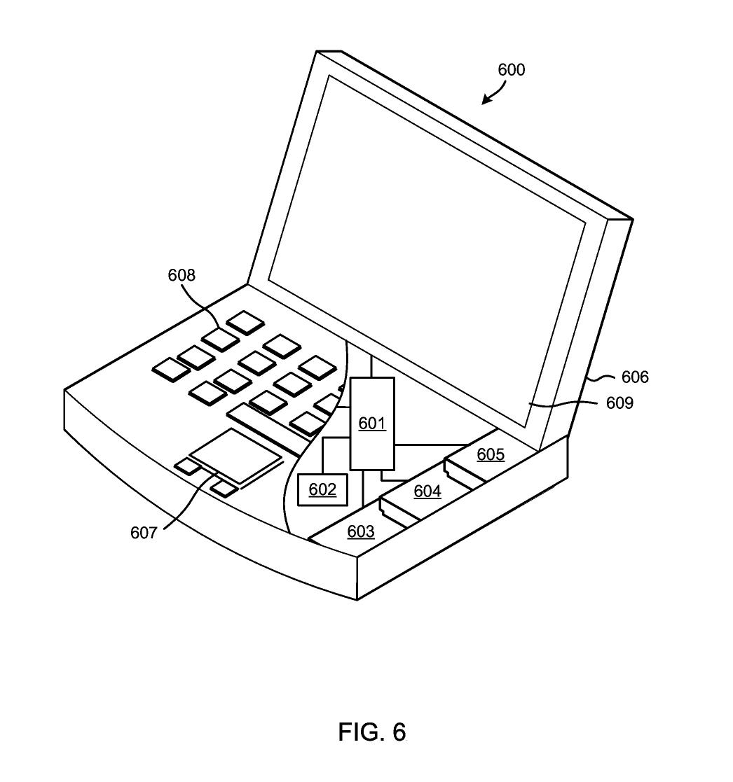

As described above, the central management system and/or other systems configured to implement the methods of the various embodiments, may comprise the computing device 518. In an example embodiment, computing device 518 may be at least one notebook computer 600 illustrated in FIG. 6. Such a notebook computer 600 typically includes a housing 606 that contains a processor 601 coupled to volatile memory 602 and to a large capacity nonvolatile memory, such as a disk drive 603. The computer 600 may also include a floppy disc drive 604 and a compact disc (CD) drive 605 coupled to the processor 601. The computer housing 606 typically also includes a touchpad 607, keyboard 608, and the display 609.

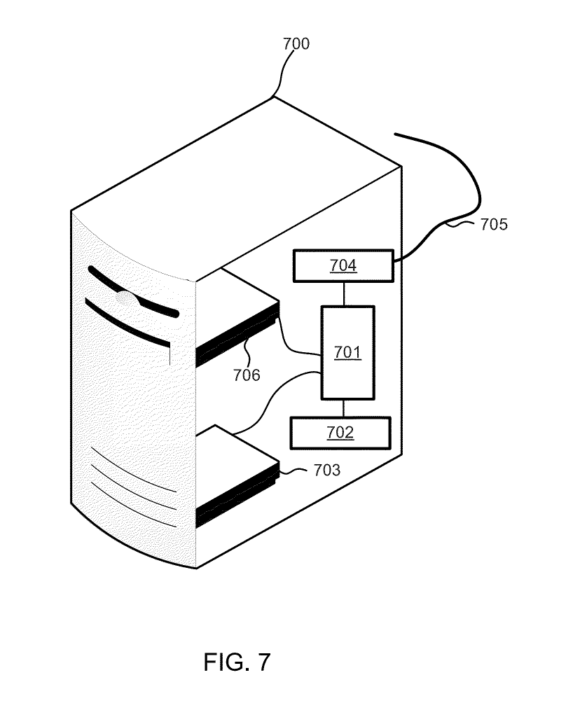

In another embodiment, computing device 518 may be at least one remote server device, such as the server 700 illustrated in FIG. 7. Such a server 700 typically includes a processor 701 coupled to volatile memory 702 and a large capacity nonvolatile memory, such as a disk drive 703. The server 700 may also include a floppy disc drive and/or a compact disc (CD) drive 706 coupled to the processor 701. The server 700 may also include a number of connector ports 704 coupled to the processor 701 for establishing data connections with network circuits 705.

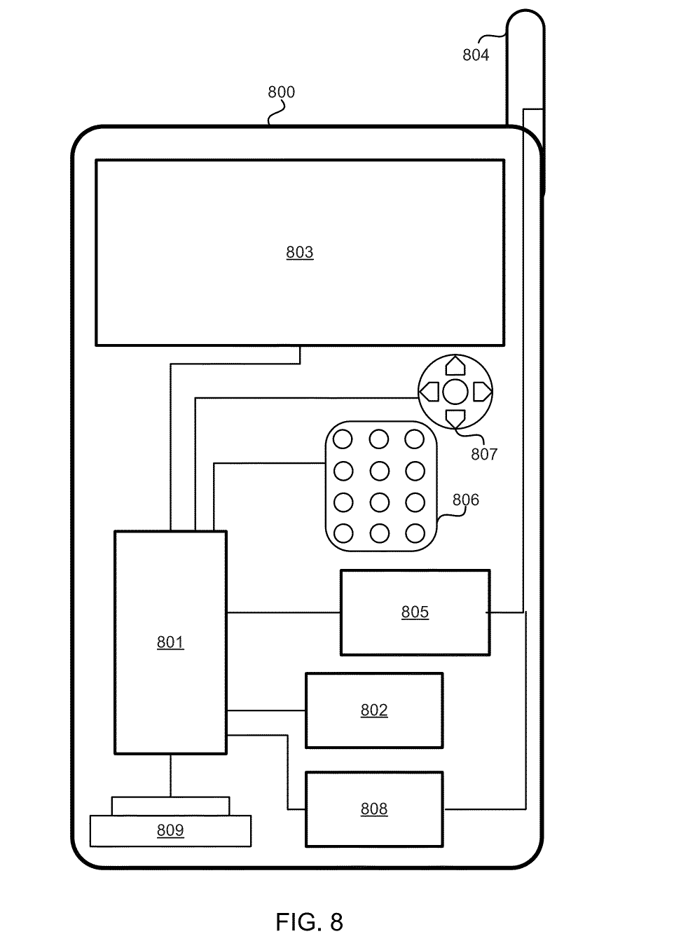

In another embodiment, computing device 518 may be at least one of a variety of mobile handsets, such as, for example, cellular telephones, personal data assistants (PDA) with cellular telephone, mobile electronic mail receivers, mobile web access devices, and other processor-equipped devices that may be developed in the future that connect to a wireless network. Typically, such mobile handsets will have in common the components illustrated in FIG. 8. For example, a mobile handset 800 may include a processor 801 coupled to internal memory 802 and a display 803. Additionally, the mobile handset 800 will have an antenna 804 for sending and receiving electromagnetic radiation that is connected to a wireless data link and/or cellular telephone transceiver 805 coupled to the processor 801. In some implementations, the transceiver 805 and portions of the processor 801 and memory 802 used for cellular telephone communications is referred to as the air interface since it provides a data interface via a wireless data link. Additionally, the mobile handset 800 will include a close range transceiver 808 capable of establishing and communicating a close range communication link, such as using one of the near field communication protocols. In some embodiments, the mobile handset 800 may include a scanner 809 (e.g., a barcode scanner) that may obtain optical image information, convert the information to digital data, and pass the data to the processor 801. Mobile handsets typically include a key pad 806 or miniature keyboard and menu selection buttons or rocker switches 807 for receiving user inputs.

The computing device processor 601, 701, 801 may be any programmable microprocessor, microcomputer or multiple processor chip or chips that can be configured by software instructions (applications) to perform a variety of functions, including the functions of the various embodiments described above. In some Central Processing Entities, multiple processors 601, 701, 801 may be provided, such as one processor dedicated to wireless communication functions and one processor dedicated to running other applications. The processor may also be included as part of a communication chipset.

The various embodiments may be implemented by a computer processor 601, 701, 801 executing software instructions configured to implement one or more of the described methods or processes. Such software instructions may be stored in memory 605, 702, 802, in hard disc memory 603, on tangible storage medium or on servers accessible via a network (not shown) as separate applications, or as compiled software implementing an embodiment method or process. Further, the software instructions may be stored on any form of tangible processor-readable memory, including: a random access memory 605, 702, 802, hard disc memory 603, a floppy disk (readable in a floppy disc drive 604), a compact disc (readable in a CD drive 605), electrically erasable/programmable read only memory (EEPROM), read only memory (such as FLASH memory), and/or a memory module (not shown) plugged into a central command server 14 such as an external memory chip or USB-connectable external memory (e.g., a “flash drive”) plugged into a USB network port. For the purposes of this description, the term memory refers to all memory accessible by the processor 601, 701, 801 including memory within the processor 601, 701, 801 itself.

As discussed above, the computing device 518 may be a remote system configured to allow a user to transmit refrigerant tracking information to, and receive refrigerant tracking information from, a separate central management system. In various embodiments the separate central management system may include a web server, and the computing device 518 may be a personal computing device configured to run a general internet browser application. Using the browser, a user may navigate to a web page that may provide real time access to the information gathered in the central management system, such as through a web portal or intranet dashboard. In other embodiment, the computing device 518 may be a mobile computing device configured to interact with the central management system information via a mobile application specifically designed for such purpose. The mobile application may be provided on a number of mobile operating systems, including, without limitation, iOS (through Apple iTunes store), Android (through Google Play), etc. FIG. 9 illustrates one example of a graphical user interface 900 provided by an embodiment mobile application, such as may be implemented by computing device 518 as a remote system. In an embodiment, the graphical user interface may provide six selectable soft keys on a touchscreen, corresponding to the following functions: Adding refrigerant gas to a Refrigerant Asset System to be tracked, picking up and dropping off refrigerant gas container movement between each location point, checking the details of a specific asset identified by either a barcode scan or by a search of the Refrigerant Asset System, and tracking refrigerant gas movement between containers. The graphical user interface on the touchscreen may be configured to receive user selection of one or more soft key in the various embodiments.

The various embodiments of the invention provide one or more of the following non-limiting advantages: Bringing information technology and business intelligence to refrigerant users; providing proprietary refrigerant tracking and management solutions, including using a mobile application, website management, and barcoded assets; providing the ability to track a refrigerant throughout its lifecycle and across value chains, visibility into technician activity, equipment maintenance histories, and inventory control; providing a refrigeration system equipment owner to manage refrigerant as an asset by preserving and reusing the refrigerant gas and/or returning the refrigerant for sale to another equipment owner; allowing refrigeration system owners to see who has handled the refrigerant they are using; allowing servicers of refrigeration system equipment to track how their technicians manage refrigerant (i.e., highlighting opportunities to increase operational efficiencies, reducing losses, identifying individuals who could benefit from more training, etc.).

The various embodiments of the invention include a Refrigerant Asset System that provides one or more of the following non-limiting advantages: use of a proprietary tracking technology that tracks the location of every unit of refrigerant gas from the point of purchase through the end of life; transparent handling of assets across a value chain and transparency across the supply chain; environmental compliance information and metrics; multiple asset optimization options (e.g., when to sell refrigerant or hold in reserve, how to maximize reuse and minimize loss, etc.); real time information for business and compliance; and access to markets and innovative end of life solutions.

Further, the Refrigerant Asset System of the various embodiments provides one or more of the following non-limiting advantages: Allowing a reclaimer to tag a recovery gas container and add it to a Refrigerant Asset System; allowing the reclaimer to ship the recovery gas container to a distributor; allowing the distributor to distribute both a clean refrigerant gas container and a recovery gas container to a mechanical contractor; allowing the mechanical contractor to service a refrigeration system by evacuating the used refrigerant gas into the empty container, charging the system with the clean refrigerant gas and recording the transfers via the Refrigerant Asset System application or web dashboard; allowing the mechanical contractor to return used refrigerant gas to the distributor by exchanging filled recovery container with another recovery gas container; allowing the distributor to send the filled recovery container to the reclaimer; allowing updating to the Refrigerant Asset System information in real time; and allowing the refrigeration system equipment owner to see an information log showing the recovered gas from the filled recovery container now available.

The various embodiments include features and services relating to the Refrigerant Asset System that provide or more of the following non-limiting advantages: an asset tracking and strategic planning service provides barcodes, mobile applications, and a website to trace movement of refrigerant as it changes hands, allows data to be entered from a mobile device, provides real time updates through report sand dashboards focusing on use in the field, and provides visibility into the volume, location and quality of all refrigerant gasses in facilities, supply chains and reserves; a reserve cleaning service allows a user to pay by the unit for recovered refrigerant to be processed back to a clean grade and stored for reuse; a reserve return service allows a user to log into the Reserve Asset System to request the transfer of stored refrigerant to any location; a disposal service allows a user to pay for the destruction of any unusable gas; a logistics service provides shipment of refrigerant to and from a reclaimer; a monetization service allows a user to sell refrigerant gas to another Refrigerant Asset System customer or to an outside buyer, and allows creation of carbon credits through ensuring destruction of gas under verified process.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the steps as a sequential process, many of the steps can be performed in parallel or concurrently.

Any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A method for managing a refrigerant gas lifecycle, comprising:
tracking distribution of a first container of clean refrigerant gas to a cooling system site;
tracking installation of the clean refrigerant gas, wherein the clean refrigerant gas is transferred from the first container into the cooling system;
tracking removal of a used refrigerant gas from the cooling system into a second container; and
tracking recycling of the used refrigerant gas, wherein contaminants are removed from the used refrigerant gas to reclaim the clean refrigerant gas.

2. The method of claim 1, wherein the second container comprises a same or a different container as the first container.

3. The method of claim 1, wherein the first and second containers comprise gas cylinders.

4. The method of claim 1, wherein the distribution, installation, removal, and recycling steps are performed by two or more separate entities.

5. The method of claim 1 wherein the distribution, installation, removal, and recycling steps are performed by a single entity.

6. The method of claim 1, further comprising:
generating reports for compliance with at least one regulatory requirement, wherein the at least one regulatory requirement relates to at least one of using the refrigerant gas and disposing of the refrigerant gas.

7. The method of claim 1, further comprising reporting at least one environmental metric, wherein:
the at least one environmental metric relates to at least one of using the refrigerant gas and disposing of the refrigerant gas; and
the at least one environmental metric is verified by an independent auditing entity.

8. The method of claim 7, wherein the environmental metric comprises a measure generated by the management system of emissions avoided by the distribution, installation, removal, and recycling steps.

9. The method of claim 7, wherein reporting the at least one environmental metric that is verified by the independent auditing entity is performed as part of a carbon credit exchange program.

10. The method of claim 1, further comprising calculating a loss of refrigerant gas during cooling system use.

11. The method of claim 10, wherein calculating the loss of refrigerant gas comprises:
measuring mass of the clean refrigerant prior to installation in the cooling system;
measuring mass of the used refrigerant after removal from the cooling system; and
calculating the difference between the mass of the clean refrigerant and the mass of the used refrigerant.

12. The method of claim 1, further comprising generating at least one financial metric.

13. The method of claim 12, further comprising determining a change in value of the refrigerant gas over a time period by:
determining the value of the refrigerant gas at the beginning of the time period; determining the value of the refrigerant gas at the end of the time period; and
calculating the difference between the beginning and end values of the refrigerant gas.

14. The method of claim 13, wherein determining the value of the refrigerant gas comprises applying a price per unit of the clean refrigerant gas to a current amount of the refrigerant gas.

15. The method of claim 13, further comprising tracking an end of life of the used refrigerant gas, wherein the used refrigerant gas is destroyed or converted.

16. The method of claim 1, wherein tracking recycling of the used refrigerant gas comprises:
generating recycling information about the used refrigerant gas, wherein the recycling information relates to the tracked distribution, installation, and removal steps; and
computing an environmental benefit calculation based on further use of a recycled refrigerant gas comprising the reclaimed clean refrigerant gas.

17. The method of claim 16, wherein the recycling information comprises:
an identification of at least one intermediary source of the recycled refrigerant gas, wherein each intermediary source comprises at least one container of used refrigerant gas;
an identification of at least one original source of the recycled refrigerant gas, wherein each original source comprises at least one container of clean refrigerant gas that is newly manufactured; and
an identification of each transfer of the at least one intermediary source and the at least one original source of the recycled refrigerant gas, wherein the identification of each transfer includes information about the location, date, and parties involved in the transfer.

18. The method of claim 17, wherein:
the identification of each transfer further includes a recorded measurement of refrigerant quantity.

19. The method of claim 16, further comprising:
generating a recycling log corresponding to the recycled refrigerant gas, wherein the recycling log contains the environmental benefit calculation, and the recycling information in a user-readable format; and
providing the recycled refrigerant gas and corresponding recycling log to an end user,
wherein the recycling log verifies that the recycled refrigerant gas was reclaimed from the used refrigerant gas.

20. The method of claim 16, wherein computing the environmental benefit calculation comprises:
determining an amount of greenhouse gas (GHG) emissions saved by an end user's further use of the recycled refrigerant gas compared to a newly manufactured refrigerant gas; and
subtracting an amount of GHG emissions expended in delivering the recycled refrigerant gas to the end user.

21. The method of claim 20, wherein computing the environmental benefit calculation further comprises subtracting an amount of GHG emissions expended in the distribution, installation, removal, and recycling steps.

22. The method of claim 21, further comprising:
accessing GHG emissions data about the end user, wherein the GHG emissions data is used to calculate a carbon footprint of the end user; and
calculating an updated carbon footprint of the end user by adjusting the GHG emissions data about the end user by the computed environmental benefit; and
providing the updated carbon footprint of the end user in the recycling log.

23. The method of claim 20, further comprising:
determining an amount of environmental credits that corresponds to the computed environmental benefit calculation; and
providing the determined amount of environmental credits to the end user, wherein the environmental credits are part of an accreditation program.

24. The method of claim 19, wherein generating the recycling information and generating the recycling log are performed by a single entity.

25. The method of claim 19, wherein generating the recycling information and generating the recycling log are performed by two or more entities.
